(19) United States
(12) Patent Application Publication
(10) Pub. No.: US 2012/0159366 A1
(43) Pub. Date: Jun. 21, 2012

(54) METHOD FOR SERVICING FIELD DEVICES IN AN AUTOMATION PLANT

(75) Inventors: Markus Klein, Malsch (DE); Jan Merkel, Mutterstadt (DE); Peter Jack, Karlsruhe (DE)

(73) Assignee: CodeWrights GmbH, Karlsruhe (DE)

(21) Appl. No.: 13/311,846

(22) Filed: Dec. 6, 2011

(30) Foreign Application Priority Data
Dec. 8, 2010 (DE) 10 2010 062 661.9

(51) Int. Cl. G06F 3/048

(52) U.S. Cl. 715/769; 715/841

(57) ABSTRACT

A method for servicing field devices. The servicing of field devices occurs via at least one service unit and corresponding device driver comprehensively describing the field devices, wherein the method comprises method steps as follows: a user is provided on a display a menu structure with a plurality of different menus, wherein the menus describe properties of the field device and/or of the process, in which the field device is installed; the user selects a successive individual menu, which are required for the particular application; the menu elements predetermined by the menu are made available; the user selects from the menu elements those, which are suited for the particular application and configures a user-defined menu structure for the corresponding field device; the configured user-defined menu structure is stored, and, based on the user defined menu structure, the field device is serviced via the device driver associated with the field device.

The invention relates to a method for servicing field devices in an automation plant, wherein the servicing of the field devices occurs via at least one service unit and corresponding device drivers or device descriptions comprehensively describing the field devices. The terminology, servicing of field devices, refers quite generally to the parametering, or the configuration, of the field devices, as well as to performing a diagnosis on one of the field devices. In the simplest case, ‘servicing of a field device’ means the representation of information concerning the field device on a display.

In process- as well as in manufacturing-automation technology, field devices are often applied, which serve for registering and/or influencing process variables. Serving for registering process variables are measuring devices, such as, for example, fill level measuring devices, flow measuring devices, pressure- and temperature measuring devices, pH-measuring devices, conductivity measuring devices, etc., which register the corresponding process variables, fill level, flow, pressure, temperature, pH-value, or conductivity. Used for influencing process variables are actuators, such as valves or pumps, via which e.g. the flow of a liquid in a pipeline or the fill level of a medium in a container is changed. Thus, in connection with the invention, the term ‘field devices’ refers to all types of measuring devices and actuators.

In connection with the invention, the term ‘field devices’ refers, moreover, also to all devices, which are applied near to the process and which deliver, or process, process relevant information. Besides the earlier named measuring devices/sensors and actuators, also referred to as field devices are generally any units, which are connected directly to a fieldbus and which serve for communication with the superordinated unit. Thus, units such as remote I/Os, gateways, linking devices and wireless adapter, or radio adapters are also field devices. A large number of such field devices are available from the Endress+Hauser group of companies.

In modern industrial plants, communication between at least one superordinated control unit and the field devices occurs, as a rule, via a bus system, such as, for example, Profibus® PA, Foundation Fieldbus® or HART®. The bus systems can be embodied both hardwired as well as also wirelessly. The superordinated control unit serves for process control, process visualizing, process monitoring as well as for the start-up and servicing of field devices and is also referred to as a configuration/management system.

The integration of field devices in configuration- or management systems occurs via device descriptions, which enable that the superordinated control units, or servicing units, can detect and interpret the data delivered from the field devices. Device descriptions for each field device type, or for each field device type in different applications, are, as a rule, provided by the respective device manufacturer. In order that the field devices can be integrated in different fieldbus systems, different device descriptions for the different fieldbus systems must be created. Thus there are—in order to name only some examples—HART-, Fieldbus Foundation- and Profibus device descriptions. The number of device descriptions is very large and corresponds to the large number of different field devices, or field device types in different applications and bus systems.

For the purpose of creating a unitary description language for field devices, the Fieldbus Foundation (FF), the HART Communication Foundation (HCF) and the Profibus Nutzerorganisation (PNO) have created a unified electronic device description language (Electronic Device Description Language EDDL). The EDDL, or the corresponding Electronic Device Description EDD is defined in the standard TEC 61804-2.

Besides the above described device descriptions, there are so-called Device Type Managers (DTM), or device managers or device drivers, which require as runtime environment an FDT-frame. DTMs serve for the comprehensive servicing of field devices and correspond to the FDT—Field Device Tool—Specification. The FDT-Specification, as an industrial standard, is an interface specification and was developed by the PNO—Profibus User Organisation—in cooperation with the ZVEI—Zentralverband Elektrotechnik- and Elektroindustrie (The German Electrical and Electronics Industry)-; the respective current FDT-Specification is obtainable from the ZVEI, or the PNO, or the FDT-Group.

The configuration and, respectively, parametering of field devices is made difficult by is the fact that the number of parameters per field device often very large. Thus, some hundred parameter are no rarity in process automation. From the large number of parameters, a user must find the parameters for its application and correspondingly parameter the device. If, moreover, of concern is an automation plant, in which a large number of field devices are installed, then the servicing of field devices is connected with very large effort.

An object of the invention is to provide a method, which enables a simple and comfortable servicing of field devices when using device drivers or device descriptions.

The object is achieved in a first form of embodiment by a method, which includes method steps as follows:
A user is provided on a display a menu structure with a plurality of different menus, wherein the menus describe properties of the field device and/or of the process, in which the field device is installed,;
the user selects successive individual menus, which are required for the particular application;
   the menu elements predetermined by the menu are made available;
the user selects from the menu elements those, which are suited for the particular application and configures a user-defined menu structure for the corresponding field device;
the configured, user-defined menu structure is stored;
based on the user defined menu structure, the field device is serviced via the device driver associated with the field device.

If, at a later point in time, changes and adaptations are required, the user can access the user-defined menu structure and match such dynamically to the changed conditions. Likewise, the user can apply the user-defined menu structure, when other field devices of the same type, for which the menu structure has been defined, must be serviced, especially parametered.

The field device is preferably a field device for determining and/or monitoring a physical, chemical or biological, process variable. Of course, in connection with the invention, all the field devices named in the introduction can be installed in the method of the invention.

Especially advantageous in connection with the method of the invention is when the field device is parametered and/or configured via the device driver associated with the field device, wherein the device drivers are integrated in a suitable frame application, especially the FDT frame.

Preferably, the configured user-defined menu structure is stored, in each case, in the device driver instance associated with the field device, or in the device driver project. Thus, the structure is explicitly associated with the corresponding field device. Moreover, it is provided, that the configured user-defined menu structure is stored in the corresponding field device.

The object is achieved according to a second form of embodiment by a method, which includes method steps as follows:
A user is provided on a display a menu structure with a plurality of different menus, wherein the menus describe properties of the field device and/or of the process, in which the field device is installed,;
the user selects successive individual menus, which are required for the particular application;
   the menu elements predetermined by the menu are made available;
the user changes the menu structure in such a manner that a user-defined menu structure is configured for the corresponding field device;
the configured user-defined menu structure is stored;
based on the user defined menu structure, the field device is serviced via the device driver associated with the field device.

The individual method steps are partially different here;, however, the same result is achieved.

Especially advantageous as regards the two above defined embodiments of the method of the invention is when the user-defined menu structure is created via drag and drop method steps. This application is very comfortable for a user, since it is rapid and intuitively operable.

Moreover, it is provided that a plurality of menu configurations are stored as known profiles and, when required, are reloaded. In this way, the work is significantly facilitated for the operating personnel—and this while maintaining a high measure of flexibility.

The invention will now be explained in greater detail based on the appended drawing, the figures of which show as follows:

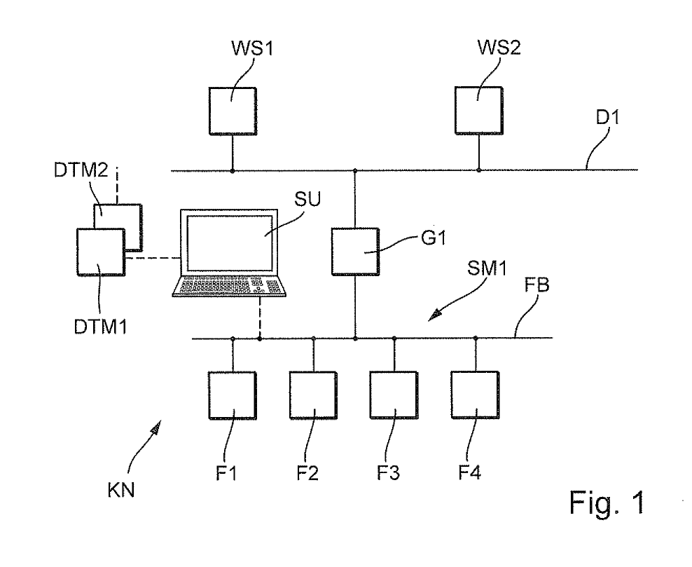

FIG. 1 a schematic representation of a communication network KN, such as is applied, for example, in process automation; and

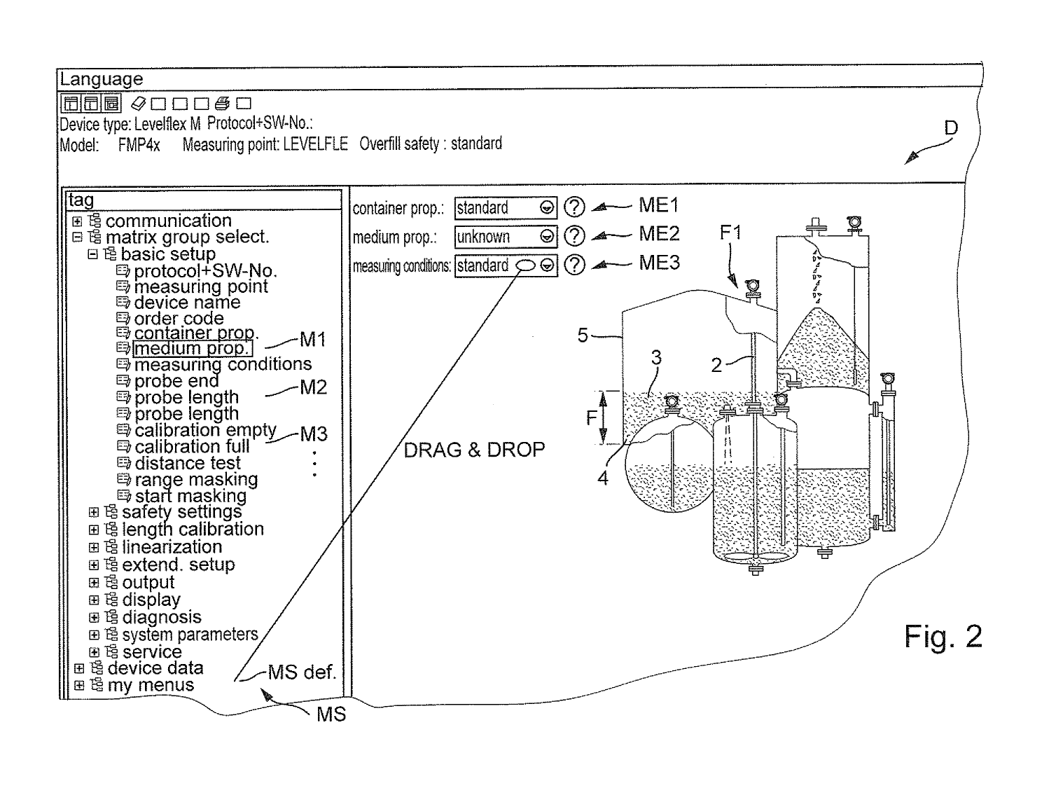

FIG. 2 a schematic representation of an embodiment of an arrangement, which illustrates the method of the invention.

FIG. 1 shows schematically a communication network KN, such as used, for example, in process automation. Connected here to a data bus D1 of the control level are a number of control units (workstations, host-computers, or, generally, clients) WS1, WS2. These control units WS1, WS2 serve as superordinated units, or control structures (control system, master control, control unit, service unit SU) for process visualizing, process monitoring and for engineering, however, also for servicing and monitoring of field devices F1, F2, F3, F4. Of course, as a function of the size of the communication network KN, just one of the control units WS1; WS2; SU can be sufficient. Likewise, the service unit SU, e.g. the operating, or servicing, tool FieldCare of the Endress+Hauser group, can be arranged at the control system level or on the field plane.

In the illustrated case, the data bus D1 is a high speed data bus, on which the data are transmitted with high transmission rates. The data bus D1 works, for example, according to the Profibus® DP standard, the HSE “High Speed Ethernet”—standard of the FOUNDATION Fieldbus®, the HART standard or one of the known standards used in automation technology. Moreover, communication on the data bus D1 can also occur via TCP/IP. For the purpose of protocol conversion, in the illustrated case, the control unit WS1, WS2, SU is connected with the fieldbus segment SM1 via a gateway G1, which is also referred to as a linking device or segment coupler,. Of course, depending on the architecture of the communication network KN, the superordinated control unit can also communicate directly with the field devices of the fieldbus plane.

The fieldbus segment SM1 has a plurality of field devices F1, F2, F3, F4, which, in the shown case, communicate with one another via a relatively slow fieldbus FB, e.g. HART, Profibus PA, Fieldbus Foundation, etc. The field devices F1, 12, 13, 14 are sensors and/or actuators or other process-near components accessible via a fieldbus D; FB. Corresponding field devices F1, F2, F3, F4 are described at length in the introduction of the description. Connected, or connectable, by wire or wirelessly, with the fieldbus FB, usually temporarily, is a portable service unit SU, e.g. a laptop, a PDA, a Palm, a cell phone or some other operating element. Via this service unit SU, the operating personnel have access to the individual field devices F1, F2, F3, F4 virtually in the bypass method.

FIG. 2 shows a schematic representation of a preferred arrangement, which illustrates the method of the invention for servicing field devices F1, F2, . . . in an automation plant. The servicing of field devices F1, F2, . . . occurs via the service unit SU shown in FIG. 1 and corresponding device drivers DTM1, DTM2, . . . comprehensively describing the field devices F1, F2, . . . and integrated in the service unit SU. Shown in FIG. 2 is the display D of the service unit SU. Provided for the user on the display D is a menu structure MS with a plurality of different menus M1, M2, . . . , wherein the menus M1, M2, . . . describe properties of the field device F1, F2, . . . and/or of the process, in which the field device F1, F2, . . . is installed,.

The user selects successive individual menu M1, M2, . . . , which are required for the particular application. In the illustrated case, involved is the device-type LEVELFLEX, a product of the Endress+Hauser group. LEVELFLEX is a fill-level measuring device 1 working according to the travel time principle for continuous fill level determination or for limit level detection, in the case of which microwave pulses are introduced along a conductive element 2 in the container 5, in which the fill substance 4 to be monitored is located.

On the basis of the travel time of the echo signal reflected on the surface 3 of the fill substance 4 and taking into consideration the particular dimensions of the container 5, the fill level F of the fill substance 4 is ascertained.

As indicated in FIG. 2, both the container geometry as well as also the arrangement of the fill-level measuring device 1 on, or in, the container 5, as well as also the fill substance 4, can be very different. In order, in spite of the most varied of field device- and/or process properties, to be able to deliver correct measurement results, each field device F1, F2, . . . preferably with application of a corresponding device driver DTM1, DTM2, . . . —possibly also is the application of the corresponding electronic device description EDD—must be so parametered, that it is matched optimally to the measurement task.

From the menus M1, M2, . . . , a menu M1 is selected; in the illustrated case, the menus, ‘container properties’, ‘properties medium’, ‘measuring conditions, the correspondingly associated menu elements ME1, ME2, . . . are made available. The user selects from the menu elements ME1, ME2, . . . those, which are suited to the particular application and configures, so, a user-defined menu structure MS_{def} for the corresponding field device F1, F2, . . . Preferably, the user-defined menu structure MS_{def} is created via drag and drop method steps. The configured user-defined menu structure MS_{def} is then stored. The storing occurs either in the device driver instance associated with the field device F1, or in the device driver project. Alternatively, or in addition, the configured user-defined menu structure MS_{def} is stored in the field device F1. Based on the user defined menu structure MS_{def}, the selected field device F1 is serviced, especially parametered and/or configured, via the device driver DTM1 associated with the field device F1.

Especially advantageous is when a plurality of user-defined menu structures MS_{def}1, MS_{def}2, . . . are stored as known profiles and, when required, they are reloaded. Thus, each user can create its own profile and receives therewith an adapted view of those parameters, which are relevant for it. Since only the data relevant for the user are displayed, the user can change parameters or evaluate data faster and goal oriented, which assures a better oversight.

1-8. (canceled)

9. A method for servicing field devices in an automation plant, wherein the servicing of field devices occurs via at least one service unit and corresponding device drivers or device descriptions comprehensively describing the field devices, wherein the method comprises the method steps as follows:
a user is provided on a display a menu structure with a plurality of different menu, wherein the menus describe properties of the field device and/or of the process, in which the field device is installed;
the user selects successive individual menus, which are required for the particular application;
the menu elements predetermined by the menu are made available;
the user selects from the menu elements those, which are suited for the particular application, and configures a user-defined menu structure for the corresponding field device;
the configured user-defined menu structure is stored; and,
based on the user defined menu structure, the field device is serviced via the device driver associated with the field device.

10. The method as claimed in claim 9, wherein:
the field device is parametered and/or configured via the device driver associated with the field device.

11. The method as claimed in claim 9, wherein:
the field device is applied for determining and/or monitoring a physical, chemical or biological, process variable.

12. The method as claimed in claim 9, wherein:
the configured user-defined menu structure is stored in the device driver instance associated with the field device, or in the device driver project.

13. The method as claimed in claim 9, wherein:
the configured user-defined menu structure is stored in the corresponding field device.

14. A method for servicing field devices in an automation plant, wherein the servicing of field devices occurs via at least one service unit and corresponding device driver or device descriptions comprehensively describing the field devices, wherein the method comprises the method steps as follows:
a user is provided on a display a menu structure with a plurality of different menu, wherein the menus describe properties of the field device and/or of the process, in which the field device is installed;
the user selects successive individual menus, which are required for the particular application;
the menu elements predetermined by the menu are made available;
the user changes the menu structure in such a manner that a user-defined menu structure is configured for the corresponding field device;
the configured user-defined menu structure is stored; and,
based on the user defined menu structure, the field device is serviced via the device driver associated with the field device.

15. The method as claimed in claim 9, wherein:
the user-defined menu structure is created via drag and drop method steps.

16. The method as claimed in claim 9, wherein:
a number of user-defined menu structures are stored as known profiles and, when required, are loaded.
